(19) United States
(12) Patent Application Publication
(10) Pub. No.: US 2008/0141335 A1
(43) Pub. Date: Jun. 12, 2008

(54) Provisioning software with policy-appropriate capabilities

(75) Inventor: Kasman E. Thomas, Wilton, CT (US)

Correspondence Address: KING & SCHICKLI, PLLC, 247 NORTH BROADWAY, LEXINGTON, KY, 40507, US

(73) Assignee: Novell, Inc.

(21) Appl. No.: 11/635,845

(22) Filed: Dec. 8, 2006

(51) Int. Cl. G06F 21/22

(52) U.S. Cl. 726/1

(57) ABSTRACT

Apparatus and methods are described for enabling distribution of user-tailored pieces of a larger software program in a way that facilitates compliance with organizational policies around security, access control, and the like. The pieces, representing new or missing functionality in an existing instance of pre-installed software, are supplied as supplemental software fragments (known as “aspects”) that provide the new or missing logic to a target application with the target application having to know of the fragment's existence. The number and quality of aspects provisioned to the user are tailored to the user's identity and/or organizational role in accordance with explicit policy governing such provisioning. In this manner, the user of the software gains functionality appropriate to his security level, title, or other qualifications, and the events surrounding the provisioning become loggable, traceable, and verifiable.

### FIELD OF THE INVENTION

Generally, the present invention relates to computing environments, especially where users are provisioned with software capabilities according to predetermined policies. Particularly, it relates to customization of a given instance of a piece of software based on the user's identity and role. Various features of the invention relate to computer software products, systems for same and methods. Use of aspect oriented programming (AOP) is another noteworthy feature.

### BACKGROUND OF THE INVENTION 2

Entities involved in developing software products have for some time been known to provide security-oriented locked code, made unlocked, upon authenticating a proper license, providing a proper handshake, or decrypting encryption, for example. With these approaches, however, the code of the underlying software program often implements intrusive unlocking logic entangled therein. With upgrades of the software, the unlocking logic must be overlaid or tediously retrofitted within the program logic of the program. This is cumbersome, at best, to achieve in practice and becomes worse the larger the code. Security-oriented approaches also have no ability to discern policies, much less policies about the user of the product. That is, the unlocking of code or not represents crude decision making about the product itself, e.g., if the license is authentic, unlock it. If not, keep it locked.

Also, software programs sometimes issue patches that either add new functionality or enable (or fix) existing functions that were previously disabled or broken. Sometimes, such fixes or “patches” are intended to correct security flaws. However, patches regularly contain new versions of objects or other logic completely lacking in the original program. In this regard, patches are frequently sizable chunks of (non)contiguous logic added to or swapped with existing logic. Increasingly, the sheer size and complexity of the target application presents formidable difficulties in continually applying patches to existing programs. Not infrequently, new patches are applied to previous patches, and patch management becomes an issue.

Another problem with patches relates to their inability to be easily reused and composed. By their nature, patches tend to be ad hoc and therefore have no a priori requirement that they enable convenience in either composability or reusability.

Accordingly, there is need in the art for software programs and products (and upgrades to same) tailored per user, per policy. There is further need of having (un)locking ability without tying inflexibly to security-oriented code. Adaptability of the software over time is also desirable without the burdens of patch management. Small or granular code is also desirable as is discrete, non-intrusive, rule-based, method-bound, and re-bindable code, for example. Naturally, any improvements along such lines should further contemplate good engineering practices, such as relative inexpensiveness, stability, ease of implementation, low complexity, flexibility, etc.

### SUMMARY OF THE INVENTION

The above-mentioned and other problems become solved by applying the principles and teachings associated with the hereinafter-described software provisioned with policy-appropriate capabilities. In a basic sense, software is made operational per various features according to policy determinations about a user (in or out of a user class) of a client machine upon which the software is installed. In this manner, sophisticated and close governance of the software is achieved. By using an aspect oriented programming (AOP) framework to implement the scheme, further advantage is realized in that the source code of the base software program need not be continually updated as policy changes over time. Rather, the source code of aspects (being smaller in size) can be updated with policy changes and inserted into the code at convenient locations, such as pointcuts. This adds robustness heretofore unavailable.

In a representative embodiment of usage, a first user of a software program, in the form of (for example) a spreadsheet software application, has the title or identity of president in an organization and therefore has need of knowing the final budgets of departments under his command, and is (by virtue of role) duly entitle to know such information. Each department head of the organization, e.g., second, third, fourth, etc. users of the spreadsheet software application, need not know (and may in fact be forbidden, by formal organization policy, from knowing) the budget totals of other departments. Thus, the president has need of a software product calculating and showing totals of all rows, columns, etc. of the organization, whereas an individual department head only has need of calculating and showing totals of all rows and columns, etc. for his (and only his) department. Thus, the same software program (e.g., the spreadsheet software application) has different users with different needs and entitlements (the needs/entitlements being defined by policies of the organization that require the president to have an all access pass while each department head only has a limited access view). Being able to provision the spreadsheet software application with different capabilities or features per each of the different users, per policy, and in recognition of a given individual's role, then has usefulness not afforded by the prior art. Moreover, the bulk of the executable code for the spreadsheet software application is mostly written and remains role-unaware, whereas the aspects that are inserted into the executable code are different per either the president-user or the department head-user. Alternatively stated, the totality of the program's capabilities is tailored to the user in question, per preexisting policy, and hereafter features of the invention are directed toward this end.

Methods and apparatus of the invention include software provisioned with policy-appropriate capabilities, such as software provisioned with different features depending upon a user's identity or job role, for instance. In an aspect oriented programming (AOP) approach, the executable binary of the principal software is capability-reduced (or, in an extreme case, actually inoperative), but for pointcuts in the code which can be controlled externally by one or more aspects, aspects which (once applied) thereby make the software operative, with a capability set appropriate to the intended user. In turn, the aspects relate to one or more predetermined policies about items such as who is the user of a client machine upon which the code is installed, and what are that person's role-based entitlements. Depending upon policy, the software product (as finally configured) varies as to capability per user. Representatively, full capabilities of the software are prevented, such as upon installation. Upon determining which capabilities a user of the software product requires, based on a predetermined policy, functionality of the software is upgraded, altered, etc., through the provisioning of aspects (small executable fragments) thereby enforcing policy.

In a computing system, the invention may be practiced with a client machine upon which a software product is installed in a locked down condition. An aspect store, such as a database, has a plurality of JAR files (representing archived aspects) for inclusion in the software product to make it unlocked per a policy-appropriate determination of a user of the client machine. An intermediary between the client machine and the aspect store, such as a server, interfaces between the machine and aspect store to retrieve and return one or more of the JAR files to the software product of the client machine whenever a policy-based decision associates the user with the one or more of the JAR files.

Specific AOP examples contemplate drafting Java code of the software product including a plain old Java object (POJO). A pointcut is created in the POJO for receipt of one or more aspects relating to a predetermined policy about a user of a client machine upon which the Java code is to be installed. Together, the Java code and the aspect result in an operational version of the software product for the user that is tailored according to the policy. Representative examples for drafting the code include an Eclipse product for drafting the Java code and JBoss for drafting the aspects.

In other embodiments, administrative functions, such as logging, are made part of the system in order to facilitate audit and compliance functionalities, as well as fault notification, debugging, and so on. Still other embodiments contemplate computer-readable media or downloads. Programming languages other than Java are contemplated and include, but are not limited to, certain scripting languages, such as C, C++, C#, Python, JavaScript or other.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing environment for provisioning software with policy-appropriate capabilities;

FIG. 2 is a flow chart in accordance with the present invention for provisioning software with policy-appropriate capabilities;

FIG. 3 is a flow chart in accordance with the present invention of a more detailed process for provisioning software with policy-appropriate capabilities;

FIG. 4 is a flow chart in accordance with the present invention of a representative example of code drafting for provisioning software with policy-appropriate capabilities;

FIG. 5 is a diagrammatic view in accordance with the present invention of one embodiment of representative software provisioned with policy-appropriate capabilities;

FIG. 6 is a diagrammatic view in accordance with the present invention of another embodiment of representative software provisioned with policy-appropriate capabilities; and

FIG. 7 is a flow chart in accordance with the present invention of a representative example of changing policy and provisioning software with capabilities based on the changed policy.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for policy-based provisioning of software capabilities are hereinafter described.

Preliminarily, however, features of the invention take advantage of the framework or concepts associated with aspect oriented programming (AOP). As is known, AOP is a programming paradigm that aids programmers in the separation of concerns, e.g., cross-cutting concerns, by way of encapsulating the concerns in one place (“aspects”) and calling for them at various locations to perform their role without affecting, in any intrusive way, the logic of the targeted programming modules, e.g., in such a way that they cut (logically) across the modules. Representatively, logging functions are well-known concerns that cut across modules and can be bundled as an aspect. Well known AOP frameworks for Java include, but are not limited to, AspectJ and JBoss AOP.

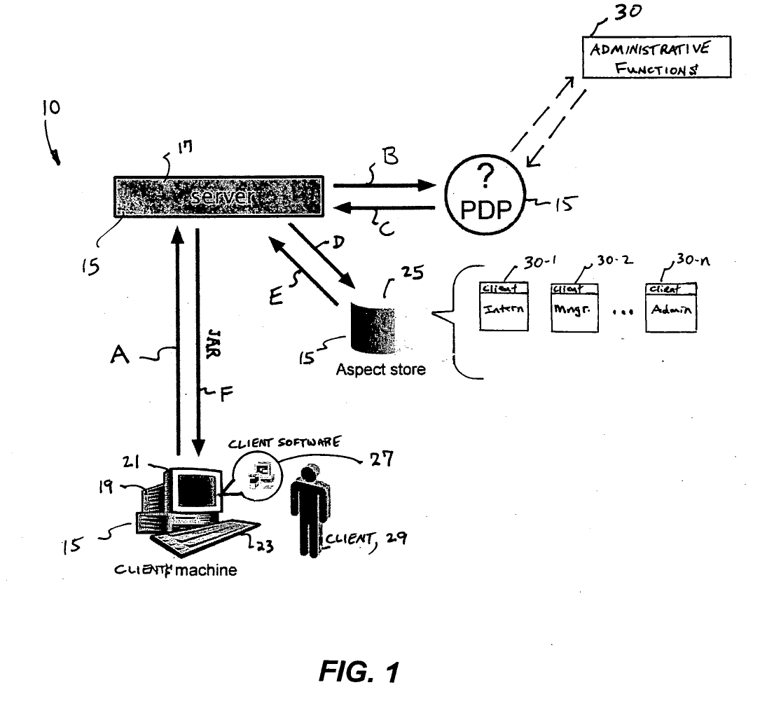

With reference to FIG. 1, a representative environment 10 for provisioning software with policy-appropriate capabilities includes one or more computing devices 15 available per the entirety of the invention or discrete features, as shown. In a traditional sense, an exemplary computing device exemplifies a stand alone server 17, such as a grid, blade or other. Alternatively, an exemplary computing device includes a general or special purpose computing device in the form of a conventional fixed or mobile computer 19 having an attendant monitor 21 and user interface 23. The computer internally includes a processing unit for a resident operating system, such as DOS, WINDOWS, VISTA, MACINTOSH, UNIX and LINUX, to name a few, a memory, and a bus that couples various internal and external units (not shown) to one another. Representative external units include, but are not limited to, PDA's, cameras, scanners, printers, microphones, joy sticks, game pads, satellite dishes, hand-held devices, consumer electronics, minicomputers, computer clusters, main frame computers, a message queue, a peer machine, a broadcast antenna, a web server, or the like.

In either, storage devices 25 are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for features of the invention contemplative of storing computer executable instructions, e.g., software (also referred to as software program products), as part of computer readable media, e.g., disk(s) 27 for insertion in a drive of computer 15, or available as a download or by way of other known or later-invented methodologies. When described in the context of computer readable media or downloads, for instance, it is denoted that items thereof, such as modules, routines, programs, objects, components, data structures, etc., perform particular tasks or implement particular abstract data types within various structures of the computing system which cause a certain function or group of functions. In form, the computer readable media can be any available media, such as RAM, ROM, EEPROM, CD-ROM, DVD, or other optical disk storage devices, magnetic disk storage devices, floppy disks, or any other medium which can be used to store the items thereof and which can be assessed in the environment. Computer executable instructions may also reside in hardware, firmware or combinations in any or all of the depicted devices.

In network, the computing devices communicate with one another via wired, wireless or combined connections that are either direct or indirect. If direct, they typify connections within physical or network proximity (e.g., intranet). If indirect, they typify connections such as those found with the internet, satellites, radio transmissions, or the like. Other items, therefore, contemplate servers, routers, peer devices, modems, T1 lines, satellites, microwave relays or the like. The connections may also be local area networks (LAN) and/or wide area networks (WAN) that are presented by way of example and not limitation. The topology is also any of a variety, such as ring, star, bridged, cascaded, meshed, or other known or hereinafter invented arrangement.

During use, the following scenario is used to illustrate a typical example for provisioning software. That is, a client 29 works or performs services for an organization and has client software 27 installed on a client machine. Upon installation, the software is locked down such that it is deemed to have very few, if any, operational features. For example, the software may be functional in one instance only to begin the process of provisioning it with capabilities specific to the client 29. In other instances, the software is functional, but unable to perform a specific role, such as printing per an identity or job role of the client. In still other instances, the software is able to provide a “demo” version of its capabilities, but no actual capabilities. Of course, other scenarios are embraced by the notion of being locked down and skilled artisans will appreciate their scope. Furthermore, but not shown, other clients in the organization also have a version of the software installed on their respective machine and it too is operationally locked down.

Thereafter, the clients will have their own version of capabilities provisioned on or with the software depending upon one or predetermined policies of the organization. In other words, the software product varies per client or user according to policies of the organization. For example, one user will get a first functionality of the software product, while another user will get another functionality of the software product different from the first. Also, the software itself will be substantially the same per each user, but only small or granularly sized changes will be implemented per user. In this manner, changes or updates in policy are easily implemented with little or no effect on the base program as will become apparent below. Clients or users can also change identities within the organization and also be outfitted with changes in functionality.

To accomplish this, pluralities of aspects 30-1, 30-2, 30-n are stored in an aspect store and particularized to an identity of the client, alone or as a class of clients, per a predetermined policy of the organization. “Policy” is typically implemented as documents (which can be XML) that specify the various roles by which access to resources may be granted or not granted to various entities in an organization. For instance, a client 29 having an identity, label or job role as that of “intern” in an organization may be limited by policy to being prevented from printing more than ten pages of any document in a word processing client software application 27 without a manger's approval. On the other hand, a client having an identity as that of manager (mngr.) would not need a page restriction on printing documents and would, therefore, have unfettered access. As such, the client 29, if a manager, would have its client software provisioned with the mngr. aspect 30-2 while the client 29, if an intern, would have its software provisioned with the intern aspect 30-1. Then, upon use, the different capabilities of the page printing limitation of the software 27 would be implemented according to policy. Heretofore, this mechanism of implementing policy has been unknown.

In another example of provisioning the software, a first user of a spreadsheet software application in an organization might have the title of president and therefore have need of knowing the final budgets of all the departments under his command while each department head of the organization, respectively known as second, third, fourth, etc. users of the spreadsheet software application, need not know the budget totals of other departments. Thus, the president has need of a software product calculating and showing totals of all rows, columns, etc. of the organization, whereas the department head only has need of calculating and showing totals of all rows and columns, etc. for his department, and published or verbal policy would make the relevant entitlements explicit. Thus, the same software program (e.g., the spreadsheet software application) is used by all users in the organization but must be constrained, as to capabilities, in a policy-driven way on a per-user basis. Provisioning the spreadsheet software application with different capabilities or features per each of the different users then has usefulness not afforded by the prior art. Moreover, as will become apparent below, the executable code for the spreadsheet software application is mostly written, but for changeable and granular-sized aspects that are inserted into the executable code per either the president-user or the department head-user. Therefore, the spreadsheet software's principal codebase remains physically and logically separable from the more granular pieces that control capabilities.

Appreciating that a near-endless variety of examples are afforded by this method, another working example includes a first user in an organization having the title of information technology (IT) administrator with predetermined policy needs of resetting and changing passwords of documents of other users. For this, a client software program 27 (such as word processing) for an administrator-user would need functionality to open password-protected documents. A second user in the organization, however, might have the title of entry level secretary and therefore only have need of being able to type documents with the same word processing software program, without ability to open other users' documents or change their passwords. Thus, the same client software program has different users with different needs (the needs being defined by policies of the organization that require an IT administrator to have password access while an entry level secretary only has need of typing with word processing). Provisioning the software with different capabilities or features per each of the different users, based on a user's role, then has usefulness not afforded by the prior art.

While the past has allowed some rudimentary uses of provisioning software, none are founded in the policy based decisions herein, much less in sophisticated use-cases in a highly “govemanced” environment managed at a fine-grained level. For example, a demonstration copy of software programs promoted without full capabilities, such as with printing disabled, until the user becomes a “privileged” user (by buying a license for the product) are known. Once privileged, the software program is made fully operational to print, whereas before, it could not. With the instant invention, however, the software program might be print-enabled for all users, but company policy prohibits any one user from printing documents more than 50 pages long unless he or she is an administrative assistant working in a Finance department of the organization. For this, the program is tailored per users to which features of the invention are directed.

In a simple flow process of the method of provisioning software, FIG. 1 teaches, at least, the following. First, the client software 27 is installed in a locked-down condition on the client machine. Second (action arrow A), client 29 authenticates to his organization's portal and requests a “license file” for his copy of the client software 27. As a result, a provisioning workflow begins. A policy decision point, or PDP, is queried (action arrow B) to determine which (if any) policies are applicable to the authenticated user's use of the client software. Policy evaluation results in an enumeration of the aspects 30 of the aspect store applicable to the client's use of the client software (action arrow C). In this regard, the PDP contemplates associating various feature(s) per client, such as limiting printing of documents to ten pages for a client-intern or enabling a president-user to have unfettered access to full spreadsheet calculations for all departments. Thereafter, a separate workflow activity (such as an “obligations service,” in XACML 2.0 parlance) queries the Aspect Store (action arrow D) to fetch or retrieve the needed aspects so enumerated or associated by way of the PDP. A packaging activity bundles those aspects into a signed JAR file, for instance, and serves the JAR first to the intermediary server 17 (action arrow E) and then to the client's machine (action arrow F). Upon the client 29 restarting their copy of now-provisioned client software 27, they find the features needed (and preferably only those features). As a result, the software has been activated and behavior-tailored. It has been “provisioned” with a highly tailored set of capabilities that is policy-appropriate for the client in their role, identity, etc. Optionally, administrative functions 30 are also provided for the PDP. In its present form, logging functions or other housekeeping matters are implemented to track associations between users and features, numbers of usage, or the like. It also represents a random or planned inquiry by the PDP as to whether any existing policies have been changed by the organization or whether any new policies have been instituted. Skilled artisans, of course, will be able to contemplate other functionality.

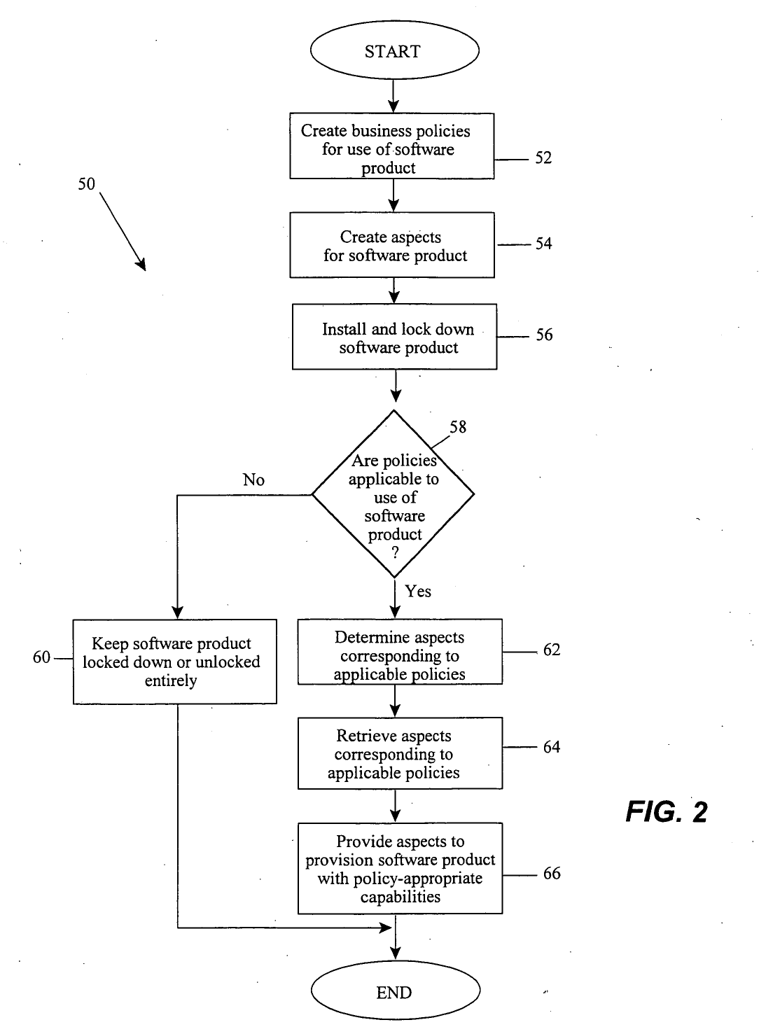

With reference to FIG. 2, a representative flow chart illustrating the foregoing is given generically as 50. In a first step, step 52, one or more business or other policies of an organization are created that define use or operation of the various software products. Continuing with a previous example, it is here where an organization determines that users with identities of “intern” have no need of printing more than ten pages or that a user with an identity of “manager” has need of unfettered printing access. Naturally, there may exist a range of policies per software products, such that some software products are completely inoperable immediately whereas others are predetermined to avoid needing any policies applied and are fully operational immediately, such as upon installation.

At step 54 (and skilled artisans will appreciate this and other steps may occur in a different order than shown, or in parallel with one another), one or more aspects are then created for the software product that relate to the identity of the users as part of the predetermined policy of step 52. Namely, an aspect for an intern would then consist of precise pieces of code to fit in a word processing software product application that prevents printing of documents of more than ten pages. Similarly, an aspect for a manager would then consist of precise pieces of code to fit in a word processing software product application that yields unfettered printing access.

At step 56, the actual installation and locking down of the software product occurs on one or more client machines in the organization. As before, the locking down is a preventing of some or all of the functionality of the software product. It may occur as crippling of the code of the software product by way of wrongly flipped bits, so to speak, or actual removal of code that may be added back later via aspects.

At step 58, a determination is made regarding whether policies are indeed applicable to a client's use of the software product, or not. If not (step 60), the software product is either: kept wholly locked down, such as in the situation that no policies have been made and therefore no client can use it regardless of reason; or unlocked in its entirety, such as in the situation that the organization cares not who uses it or how it is used. On the other hand, if policies are determined as applicable, then step 62 determines which of the specific policies apply. In so doing, it is determined which of the earlier-created aspects correspond to the policy. That is, an association occurs that links client-interns with page printing limitations and client-managers without printing limitations, to continue the analogy.

Once the applicable policies are determined, and which aspects they relate to, step 64 provides for retrieving the aspects, such as from the aspect store in FIG. 1. Finally, the retrieved aspects are then provided to the software product, step 66, thereby provisioning it with the predetermined policy. In this manner, the software product is user-tailored according to policies of the organization.

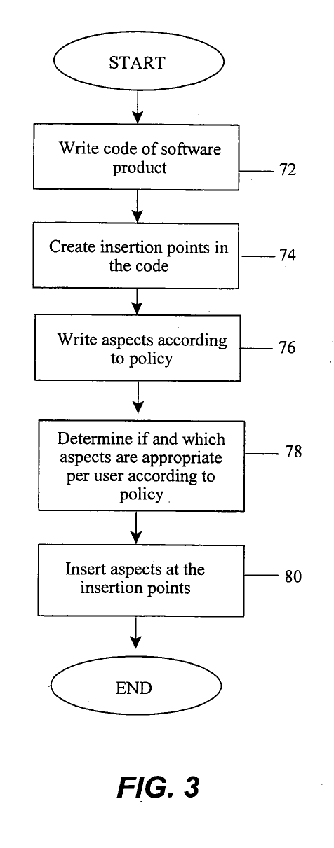

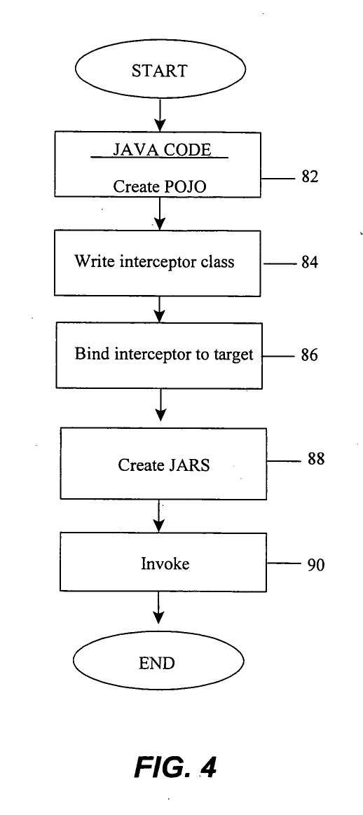

In actual programming parlance, FIGS. 3 and 4 respectively teach generic and specific flow processes for same and will be described below in parallel. At step 72, the object or source code of the software product is written. In once instance this includes Java code being written, including creation of one or more plain old Java objects (POJO), step 82.

At step 74, insertion points, such as pointcuts, are created in the otherwise written code of the previous step. In this regard, the pointcut is a location for future receipt of an aspect that is provisioned according to policy so that otherwise inoperable code of the program will become operational, for example. In the Java code, the pointcut will be a position inside the POJO. The POJO may also be known as a target.

At step 76, the aspects are created according to the predetermined policy. Again, aspects are granular pieces of code for inclusion in the code of the software product to make it operational according to step 78. That is, it is determined if any and which aspects are appropriate per user, according to the business policies of the organization.

At corresponding steps 84 and 86, this is known as writing the interceptor class, e.g., the aspects, and binding the interceptor to the target. In a generic sense, the “target” is the POJO whose functionality will be affected (or “advised”) by the aspect, while the “pointcut” within the POJO is a precise location where the aspect will intercept the flow of control.

At step 80, the aspects per user, according to policy, are then applied to (or bound to) the designated pointcuts inserted at the insertion points for provisioning the software. Of course, each user or class of users, according to predetermined policy, will enable different aspects to be applied at various pointcuts. In this manner, the software is tailored. The manner by which pointcut bindings may be specified can vary. In some AOP systems, the bindings are very specified as annotations in the POJO source code. In other systems, they are specified in external XML files. There are other possibilities as well. It will be recognized, in any case, that the manner of specifying the bindings is not, in itself, important to the utility of the invention, unless expressly claimed.

At step 88, the packaging of all artifacts necessary for making the aspects usable occurs as a result of creating (for example) JAR files, for example, which packages the code of the aspects themselves along with any necessary housekeeping items, such as config files, manifests, resource bundles, license files, MD5 digests, digital certificates, and/or other possible artifacts, for inclusion with the distributable aspect. Once packaged, the JARs are delivered to a place where the executing Java code can interact with the aspects (and vice versa) upon being invoked at step 90.

In a still more detailed implementation of the invention, the Java code is written, as is often typical, with a development tool known as Eclipse. Aspects, on the other hand, provisioned per user or client, according to policy, can be written using a JBoss AOP plugin for Eclipse. Neither the plugin nor the resulting output are dependent on a JBoss application server, however. The JBossAOP plugin simply acts to facilitate aspect-oriented Java programming in Eclipse. In this regard, the JBoss AOP plugin allows any Java object (POJO) to be “aspected.” The general procedure is as follows:

1. Write Java code for software product(s) or program(s) as normal in Eclipse. Create a plain old Java object (POJO).

2. Write an interceptor class that contains the logic intended to apply to a particular pointcut (execution spot) in the POJO. (The Interceptor interface is described further below.)

3. Bind the interceptor to its target: In Eclipse, right-click on the POJO method intended to be an instrument (in the Outline view). A context menu appears. Choose the “Apply Interceptors” command, and select the written interceptor class. When the command executes, the JBoss AOP plugin generates the XML descriptor for the aspect, and it silently does a few bytecode modifications to the POJO class so that at runtime, the interceptor gets into the call chain at the correct point. At no time is it necessary, however, to make any hand-edits or alterations to the original POJO code.

4. Create a JAR that contains the created POJO, the written interceptor class, and the descriptor.

The final JAR will now execute on any standard JVM. (The freely available JBoss-aop.jar is needed in the classpath, however.)

Naturally, creating the interceptor class means creating a class that implements org.JBoss.aop.advice.Interceptor. That interface is just:

```
    public interface Interceptor {
    public String getName( );
    public Object invoke(Invocation invocation) throws Throwable;
}
```

The XML descriptor that informs how the interceptor will be used at runtime looks like this:

```
<?xml version=“1.0” encoding=“UTF-8” standalone=“yes”?>
<aop>
    <bind pointcut=“public void com.my.ware.io.Document-&gt;
    save( )”>
    <interceptor class=“com.my.policy.aspect.FileAdvice”/>
    </bind>
</aop>
```

In English, this particular descriptor says to use the FileAdvice interceptor class whenever the save( ) method in a com.my.ware.Document object is called at runtime (in other words, invoke the invoke( ) method on my interceptor object whose classname is FileAdvice). Myware, as used herein, is also the same as the client software 27 on the client machine.

It should be noted that pointcuts can contain expressions:

<bind pointcut=“* com.my.ware.io.*-&gt;*(..)”>
<interceptor class=“com.my.policy.GovernanceCheck”/>
</bind>

The above example says to invoke the GovernanceCheck interceptor whenever any method in any class in the com.my.ware.io package is called. (The JBossAOP syntax for pointcut expressions is based on pattern matching and has been found to be quite powerful.) While the invention is dependent neither on the syntax nor expression mechanisms shown above, such mechanisms enhance the potential uses of the invention.

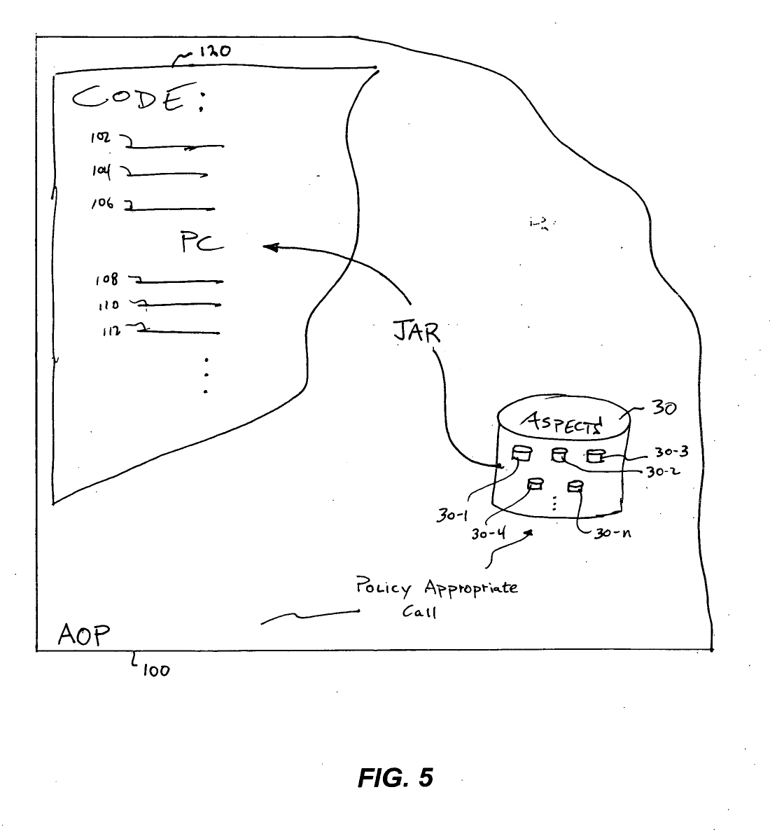

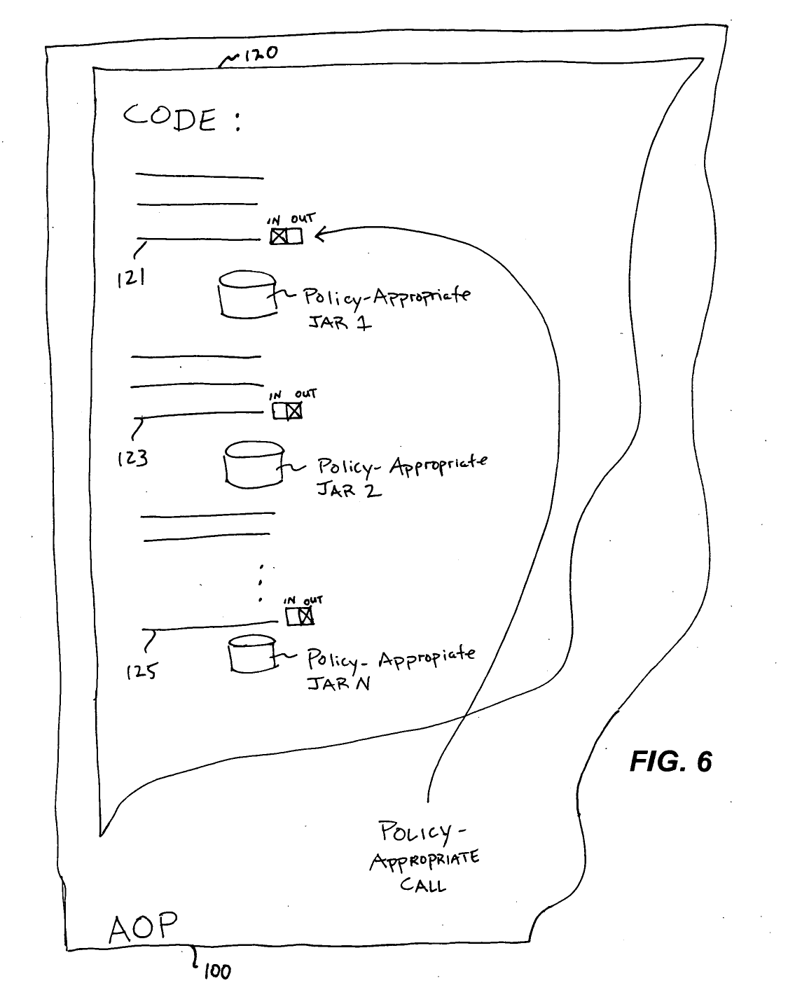

As a result, FIGS. 5 and 6 show alternate diagrammatical implementations of the actual software product. In the former, the AOP framework 100 includes the many lines 102, 104, 106, . . . 112, etc. of object or source code 120 of the underlying application. A pointcut, PC, is indicated in the code where an aspect 30 to provision the code is to be inserted, such as that bundled in a JAR. During use, the code itself is locked-down or otherwise inoperable for want of one or more aspect JARs whose executable logic can be applied at one or more pointcuts. Upon an appropriate policy-based call, per user, such as at the time of authenticating (FIG. 1), the JAR's executable code is inserted at the pointcut (action arrow F, FIG. 1) and the otherwise inoperable code 120 is made operable for no longer wanting appropriate logic at the pointcut.

In the latter, FIG. 6, the code 120 itself may already contain all the necessary JARs of policy-based aspects upon inception, such as at the time of writing. However, one or more of the lines of object or source code 121, 123, or 125 can be configured in such a way during installation, and lock down, such that the JARs are either included as part of the execution of the code or not. Upon a policy-appropriate call, the JARs are then either included “IN” or excluded “OUT” of the execution as appropriate. While this too creates an acceptable software product, hybrid products between FIGS. 5 and 6 are also acceptable as are other embodiments readily imagined by those skilled in the art.

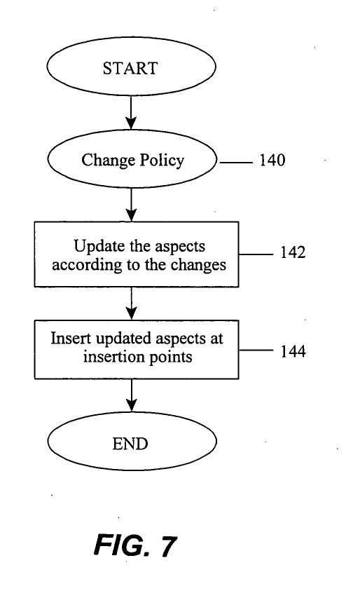

With reference to FIG. 7, another advantage of the invention relates to updating the code of the software product. For instance, a step 140 of a changed policy invites a change to the software product itself as only updating the aspects per users, according to the policy (step 142). Because pointcuts are already drawn in the code, the effect is simply to then insert the updated aspects at the insertion points, step 144. In this manner, the remaining portions of software code stay as originally drafted or written and so implementing change is independent of the original code. In other words, it is a small fix to the code and such is easily manageable. The key here is that each aspect is separate, easily modifiable, granular and easily-attached to the pointcut.

While IT experts may debate AOP as a paradigm, they nonetheless continue to search for ways to bring existing enterprise software under policy control, without having to rewrite large amounts of existing code. Thus, the foregoing instrumenting existing software with provisionable aspects is a tactic that certainly has compelling interest. Also, representative computing environments for usage contemplate one or more of the following.

In a first environment, the invention has applicability to digital rights management (DRM) in a networked environment. For example, calls to objects and methods can be monitored on a per-usage basis so that (for example) music playing devices could track usages of I/O calls, etc., including the arguments to those calls, values of instance variables at method return time, etc. In general, this invention affords extremely powerful, flexible ways to monitor program usage or charge users on a per-feature/per-invocation basis, since aspects can be written to intercept almost any program behavior.

In a second environment, the invention has applicability to online games and game playing. That is, provisioning of object- and method-level capabilities in multi-player (networked) commercial games is highly desirable from the standpoint of granular entitlement control. As is known, games typically have many “levels” of capability entitlement that must be successively unlocked through elaborate player actions (and/or payments to the game operator); and the entitlements are tightly tied to personas. The invention, therefore, allows elaborate, policy-controlled modifications to program behavior on a user-by-user basis without changes to the underlying client-program code base. The invention also has clear applicability to the policy- and identity-based provisioning of “capability personas” to set-top boxes.

In a third environment, a casino, gambling-machine software (resident on client machines) could be provisioned with new behaviors, securely and flexibly, in “govemanced” fashion (that is, in a fashion that permits audit, verifiability, fault detection, and so forth).

In a military application environment, individual “smart” weapons could be provisioned with entirely new behaviors (or highly context-tailored behaviors) from a remote server, securely and under policy control, on short notice per a user of the weapon. (Such provisioning would of course be loggable, auditable, etc.) “Smart firearms” could be provisioned (wirelessly) with up-to-date rules of engagement customized to the weapon in question and the combat context. Any behavior of the weapon that is under software control could be appropriately constrained. A central server at an appropriate command-and-control center could “update” the behavior of weapons remotely to conform with new policy at any time.

Regardless of environment, it is also contemplated that in a low-bandwidth or low-transmission-speed situations, it would be important for mission-critical software updates to be as small and granular as possible. Aspects, as described above, fit that need well.

Certain advantages of the invention over the prior art should be readily apparent to those of skill in the art. For example, the invention allows the provisioned capabilities, per user according to policy, to be policy-controlled from a central point, if desired. Thus, upgrades need not be decentralized, which can unduly complicate the product.

Because it is now possible for software capabilities to be provisioned (individually or in bundles) automatically (automated workflows) on a per-identity basis, the relevant provisioning events can be logged, monitored, etc. For this, governance comes into play at heretofore unknown levels of management.

Also, aspects (representing the implementation of policy constraints) can be stored in a central repository, e.g., aspect store, and managed separately from the targeted software. This adds programming convenience and eliminates unnecessary code entanglement.

Upon updating of policy, aspects can be updated which avoids causing a need for changes in the client-software code, e.g., 120, FIGS. 5 and 6. Due to their granularity, aspects can be revised and redeployed easily, minimizing the disruptive effect of policy changes.

In an enterprise environment, the invention also makes it feasible to install a given desktop program in a fully locked-down state by default, then unlock capabilities in policy-appropriate fashion (at a later time) based on the identity of the user.

Stated differently, some of the key benefits of the invention, without limitation, can be identified as:

1. In at least one embodiment, existing client software does not need to be revised or rewritten per each user (or class of users) per policy. Rather, the invention is non-invasive, which is a compelling advantage in IT organizations that are desirous of placing software under policy control but do not want to revisit existing code.

2. Tailoring of client-software capabilities is extremely fine-grained (to the level of object and method behavior).

3. Aspects that govern program behaviors are reusable and composable due to the way they are bound to classes and methods in the “target” software. Bindings can be specified declaratively in XML. Thus, they are maintainable on their own. More than one aspect can be bound to one class or method, and more than one class/method can be bound to one aspect.

5. The metadata syntax for binding aspect interceptor classes to target classes allows rule expressions. For example, a binding may specify that a given interceptor class should be invoked on every entry to any method whose name begins with “get” in every class in package x.y.z whose name begins with “State.” This adds an extra level of power and flexibility in implementing policy requirements.

6. Because the descriptor metadata that describe bindings are XML based, they can be signed, encrypted, used in SOAP transactions, queried with XPath, transformed with XSLT, and (in general) used in any way XML is used, using commonly available tools.

7. Since aspects are highly granular, custom capability sets are easy to define and pull together in real time.

8. Since aspects can be packaged in digitally signed, encrypted JARs, they are relatively secure against hacking. To hack an aspect-controlled program would require the hacker to reverse-engineer a potentially large number of interceptor classes and descriptors. If aspects are supplied in an encrypted form, the hacker would also need to defeat the encryption scheme in order to inspect and reverse-engineer the aspect logic.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. A method of provisioning a software product with policy-appropriate capabilities, comprising:
preventing full capabilities of the software product;
determining which capabilities of the full capabilities a user of the software product requires based on a predetermined policy; and
based on the determining, allowing functionality of the which capabilities thereby provisioning the software product with the policy.

2. The method of claim 1, wherein the allowing functionality of the which capabilities varies depending upon different users.

3. The method of claim 1, based on the determining, further including providing aspects to an otherwise incomplete code of the software product.

4. The method of claim 3, wherein the providing aspects based on the determining further includes inserting one of the aspects at a pointcut in the otherwise incomplete code, each of the aspects enabling differing functionality from other of the aspects when together with the software product.

5. The method of claim 1, wherein the allowing functionality of the which capabilities occurs by enabling aspects to function with the software product, each of the aspects enabling differing functionality from other of the aspects when together with the software product.

6. The method of claim 1, wherein the determining which capabilities further includes setting the predetermined policy based upon an identity of the user.

7. The method of claim 1, wherein the allowing functionality further includes enabling otherwise disabled aspects in object or source code of the software product.

8. The method of claim 1, further including providing the software product as one of a download and a computer readable medium.

9. A method of tailoring executable code with policy-appropriate capabilities for a user, comprising:
preventing certain capabilities of the executable code from operating;
determining which capabilities of the prevented certain capabilities the user of the executable code requires based on a predetermined policy other than a licensing arrangement based on purchase of the executable code; and
based on the determining, allowing the which capabilities of the prevented certain capabilities to operate thereby provisioning the executable code with the policy, wherein the allowing the which capabilities varies depending upon different users.

10. The method of claim 9, wherein the preventing certain capabilities further includes installing the executable code on a plurality of computing devices in an organization related to the user and the different users.

11. The method of claim 9, wherein the preventing certain capabilities of the executable code from operating further includes providing incomplete object or source code with pointcuts for receipt of one or more aspects available after the determining the which capabilities based on the predetermined policy.

12. The method of claim 9, wherein the allowing the which capabilities of the prevented certain capabilities to operate further includes retrieving aspects from an aspect store and providing the aspects to the executable code on a client machine.

13. The method of claim 9, wherein the steps of the preventing certain capabilities, the determining which capabilities, and the allowing the which capabilities of the prevented certain capabilities to operate occur remotely, locally or both in a computing environment.

14. In a computing environment, a method of provisioning a software product with policy-appropriate capabilities for a user of a client machine, comprising:
installing the software product on the client machine, the software product including an incomplete version of source or object code preventing full operation, the code including one or more insertion points;
determining which capabilities the user functionally requires for use according to a predetermined policy of an organization related to the user;
based on the determining, allowing the which capabilities to operate thereby provisioning the software product with the policy, the allowing including inserting one or more aspects of code at the one or more insertion points after the determining the which capabilities the user functionally requires for use, the inserting the one or more aspects of code also making the incomplete version of source or object code operational for the user.

15. The method of claim 14, further including updating the one or more aspects based upon changes in the policy, the updating occurring without altering the incomplete version of source or object code.

16. The method of claim 15, further including inserting the one or more updated aspects at the one or more insertion points thereby making the incomplete version of source or object code operational for the user based upon the changes in the policy.

17. The method of claim 17, wherein the allowing the which capabilities to operate varies depending upon different users.

18. A computing system, comprising:
a client machine for installation with a software product in a locked down condition;
an aspect store having a plurality of JAR files for inclusion in the software product to make it unlocked per a policy-appropriate determination of a user of the client machine; and
an intermediary interfaced between the client machine and the aspect store, the intermediary operable to fetch and return one or more of the JAR files to the software product of the client machine whenever a policy-based decision associates the user with the one or more of the JAR files.

19. The computing system of claim 18, further including an administrative function associated with the policy-based decision.

20. The computing system of claim 18, wherein the aspect store is a database and the intermediary is a server remote from the database, the database operable to have updated JAR files upon an update in policy.

21. The computing system of claim 18, wherein the software product in a locked down condition is an incomplete version of source or object code that is unable to operate without the one or more JAR files.

22. A computer readable media having computer executable instructions that is provisionally enabled with policy-appropriate capabilities, comprising:
a plurality of lines of object or source code together resulting in an inoperable software product; and
one or more pointcuts in the plurality of lines for receiving one or more aspects, the aspects relating to a predetermined policy about a user of a client machine upon which the plurality of lines are installed and the plurality of lines together with the aspects resulting in an operational software product for the user that is provisioned according to the policy.

23. The computer readable media of claim 22, wherein the plurality of lines are Java code include a POJO.

24. The computer readable media of claim 23, wherein the one or more pointcuts exist in the POJO.

25. The computer readable media of claim 23, wherein the one or more aspects vary from user to user.

26. By way of aspect oriented programming, a method of writing executable code for a software product, comprising:
drafting Java code including a POJO;
creating a pointcut in the POJO, the Java code and POJO being an inoperable software product;
drafting an aspect for insertion at the pointcut, the aspect exclusively relating to a predetermined policy about a user of a client machine upon which the Java code is to be installed, the Java code and the aspect together resulting in an operational version of the software product for the user that is provisioned according to the policy.

27. The method of claim 26, wherein the drafting the aspect varies per different users.

28. A computer software product having computer executable instructions that, when executed, operates functionally differently per different users, comprising:
a plurality of lines of object or source code with a pointcut for receipt of a first and second aspect, the first aspect relating to a predetermined policy about a first user of a computing device upon which the plurality of lines of object or source code are installed wherein the first aspect together with the plurality of lines of object or source code yield a first functionality, the second aspect relating to a predetermined policy about a second user of the computing device upon which the plurality of lines are installed wherein the second aspect together with the plurality of lines of object or source code yield a second functionality different than the first functionality.

29. A computer software product having computer executable instructions that, when executed, operates functionally differently per different users, comprising:
a plurality of lines of object or source code with a plurality of aspects embedded therein made operational differently per a first or second user, wherein the first aspect relates to a predetermined policy about a first user of a computing device upon which the plurality of lines of object or source code are installed and the first aspect together with the plurality of lines of object or source code yield a first functionality, and wherein the second aspect relates to a predetermined policy about a second user of the computing device upon which the plurality of lines of object or source code are installed and the second aspect together with the plurality of lines of object or source code yield a second functionality different than the first functionality.
